(19) United States
(12) Patent Application Publication
(10) Pub. No.: US 2026/0233649 A1
(43) Pub. Date: Aug. 13, 2026

(54) SEAT BACK

(71) Applicant: TOYOTA BOSHOKU KABUSHIKI KAISHA, Aichi-ken (JP)

(72) Inventors: Atsushi NITTA, Aichi-ken (JP); Hiroaki NATSUME, Aichi-ken (JP); Kanto TAKAHASHI, Aichi-ken (JP); Kazuki OSHIMA, Aichi-ken (JP); Masahiko IYODA, Aichi-ken (JP)

(73) Assignee: TOYOTA BOSHOKU KABUSHIKI KAISHA, Aichi-ken (JP)

(21) Appl. No.: 19/536,549

(22) Filed: Feb. 11, 2026

(30) Foreign Application Priority Data
Feb. 12, 2025 (JP) 2025-020650

(51) Int. Cl. B60N 2/68; B60N 2/22; B60N 2/64; B60N 2/72; B60N 2/90

(52) U.S. Cl. CPC B60N 2/682; B60N 2/22; B60N 2/64; B60N 2/646; B60N 2/72; B60N 2/986

(57) ABSTRACT

A seat back comprises a frame and a structure that is attached to the frame and elastically supports a seated occupant. The structure includes a main structure positioned at a center portion in a seat width direction and a pair of side structures located on both sides of the main structure. The main structure includes a main pad, a main cover that covers the main pad, and a main support member that is attached to the frame side of the main pad and supports the main pad. The main support member has ribs that extend in the seat width direction are disposed in portions of the main support member corresponding to a lower thoracic region and an upper pelvic region of the seated occupant so as to enhance rigidity. An opening for air intake is formed in an upper portion of the main support member.

### CROSS-REFERENCE TO RELATED APPLICATION

This application claims priority to Japanese patent application serial number 2025-20650 filed February 12, 2025, the contents of which are incorporated herein by reference in its entirety for all purposes.

### TECHNICAL FIELD

The present disclosure relates to a seat back.

### BACKGROUND

A seat back for a vehicle seat, such as an automobile, is known to have a seat back cover, divided into three parts in a seat width direction and assembled to a seat back frame. For example, a prior art discloses a seat back having a seat back main member, which is the central portion in the seat width direction, and two seat back side members, which are located on both sides of the seat back main member. Each of these are attached to a seat back frame separately. Such vehicle seats aim for advantages such as good assembly characteristics and suitability for automated assembly, as well as the ease of replacing only the seat back side members, which are prone to deterioration during occupant entry and exit.

According to the automobile seat described in the above prior art, the rigidity is partially increased in the seat side main member to improve ride comfort performance. Consequently, there was a problem that the structure for maintaining an appropriate seated posture was not considered.

Therefore, the objective of the present disclosure is to provide a seat back, in which a seat pad covered with a seat cover is divided into three parts in the seat width direction and attached to a frame, and where the rigidity of the main member is partially varied to improve ride comfort performance.

### SUMMARY

A seat back is disclosed, comprising a frame that forms a framework, and a structure that is attached to the frame and elastically supports a seated occupant. The cushion member includes a main structure at a center portion in a seat width direction, and a pair of side structures located on both sides of the main structure. The main structure includes a main pad, a main cover that covers the main pad, and a main support member that is attached to the frame side of the main pad and supports the main pad. Ribs extending in the seat width direction are disposed in portions of the main support member corresponding to a lower thoracic region and an upper pelvic region of the seated occupant so as to enhance rigidity.

### BRIEF DESCRIPTION OF DRAWINGS

FIG. 1 is a perspective view of an automobile seat to which a seat back according to one embodiment is assembled.

FIG. 2 is an exploded perspective view of the seat back of FIG. 1.

FIG. 3 is a front view of the seat back of FIG. 1. Only a frame and a main structure are shown.

FIG. 4 is a sectional view along a line IV-IV in FIG. 3.

FIG. 5 is an exploded perspective view of a main support member and a main pad of the main structure as seen from the rear.

### DETAILED DESCRIPTION

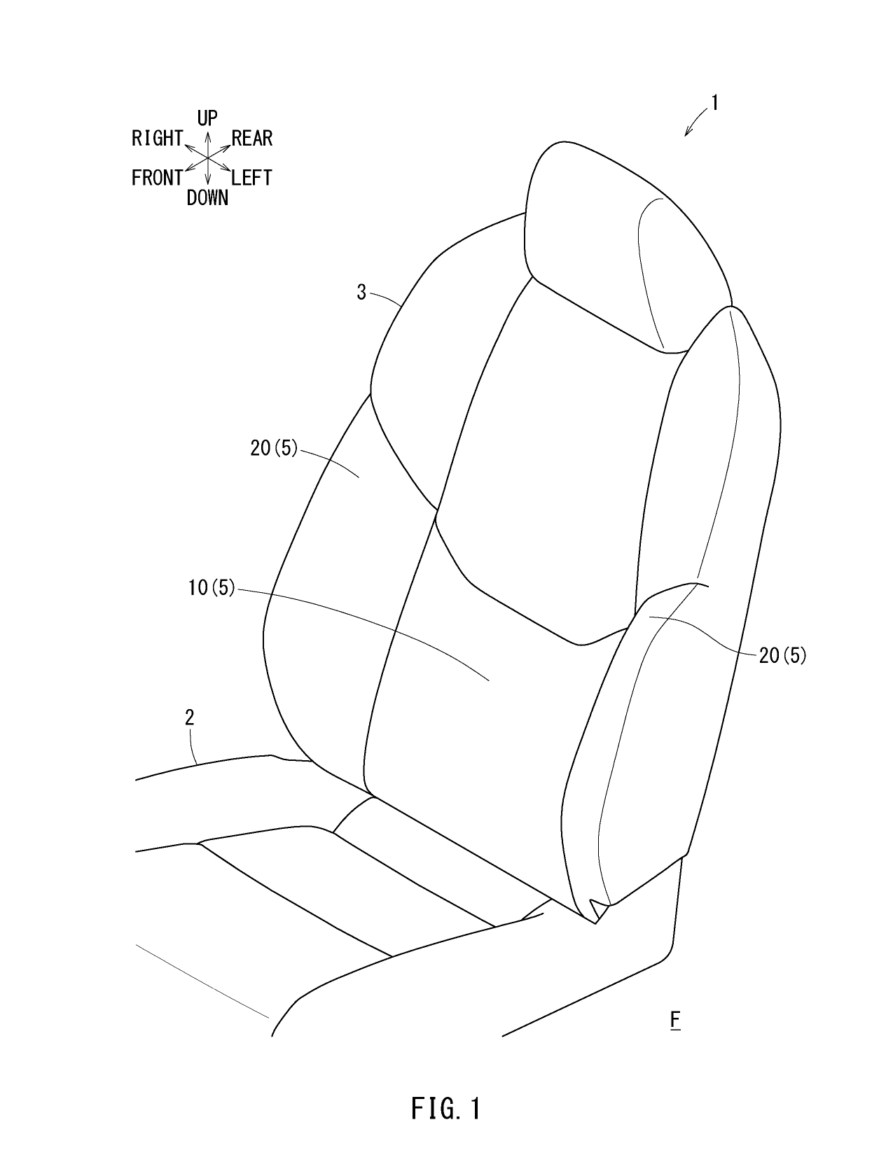

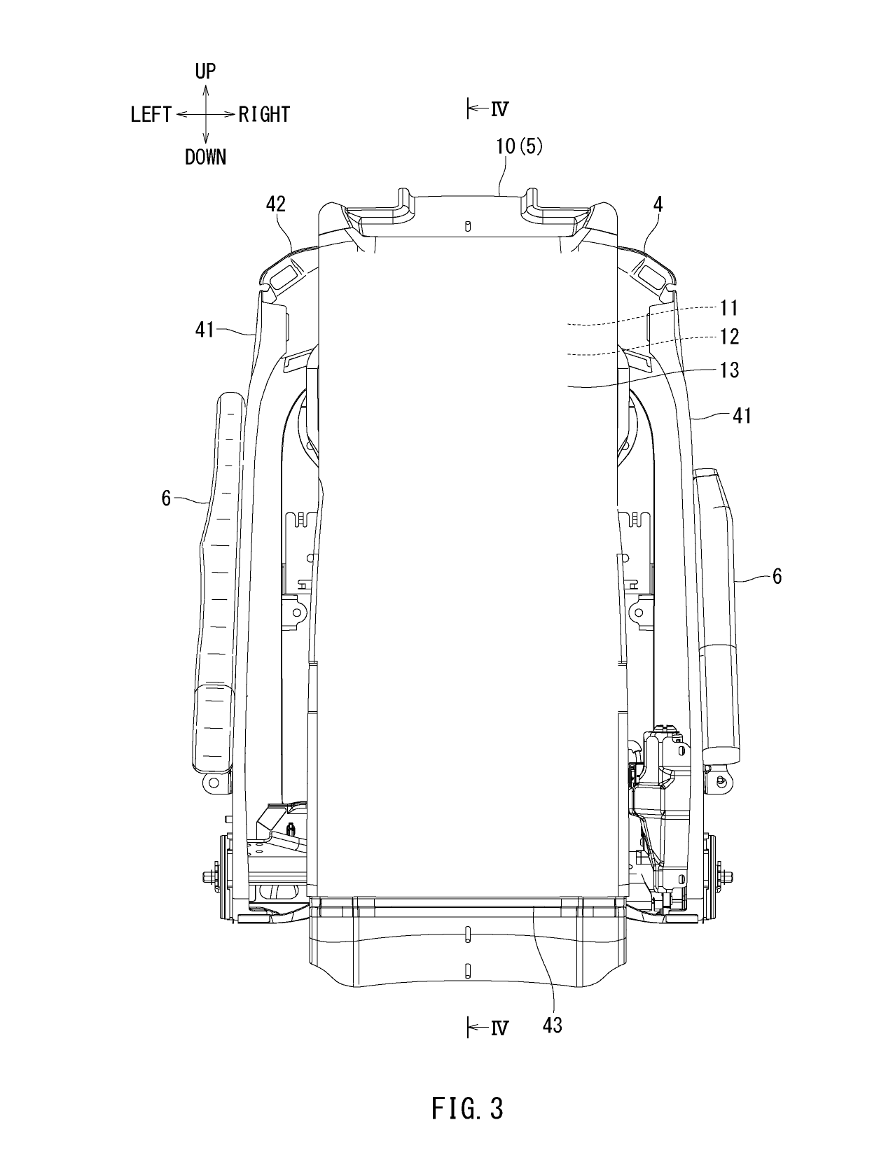

Referring to FIGS. 1 to 5, a seat back 3 of an automobile seat 1 according to an embodiment of the present disclosure will be described. In the following description, directional references (e.g., up/down, front/rear, right/left) are based on the orientations shown in the respective figure. Specifically, the up/down, front/rear, and right/left directions are defined relatively to the automobile seat 1 when the seat 1 is mounted on a floor F of the automobile. The right-left direction corresponds to a seat width direction.

As shown in FIG. 1, the automobile seat 1 includes a seat cushion 2 configured to support the buttocks and thighs of a seated occupant and the seat back 3 configured to support the lower back (lumbar) and upper back of the seated occupant.

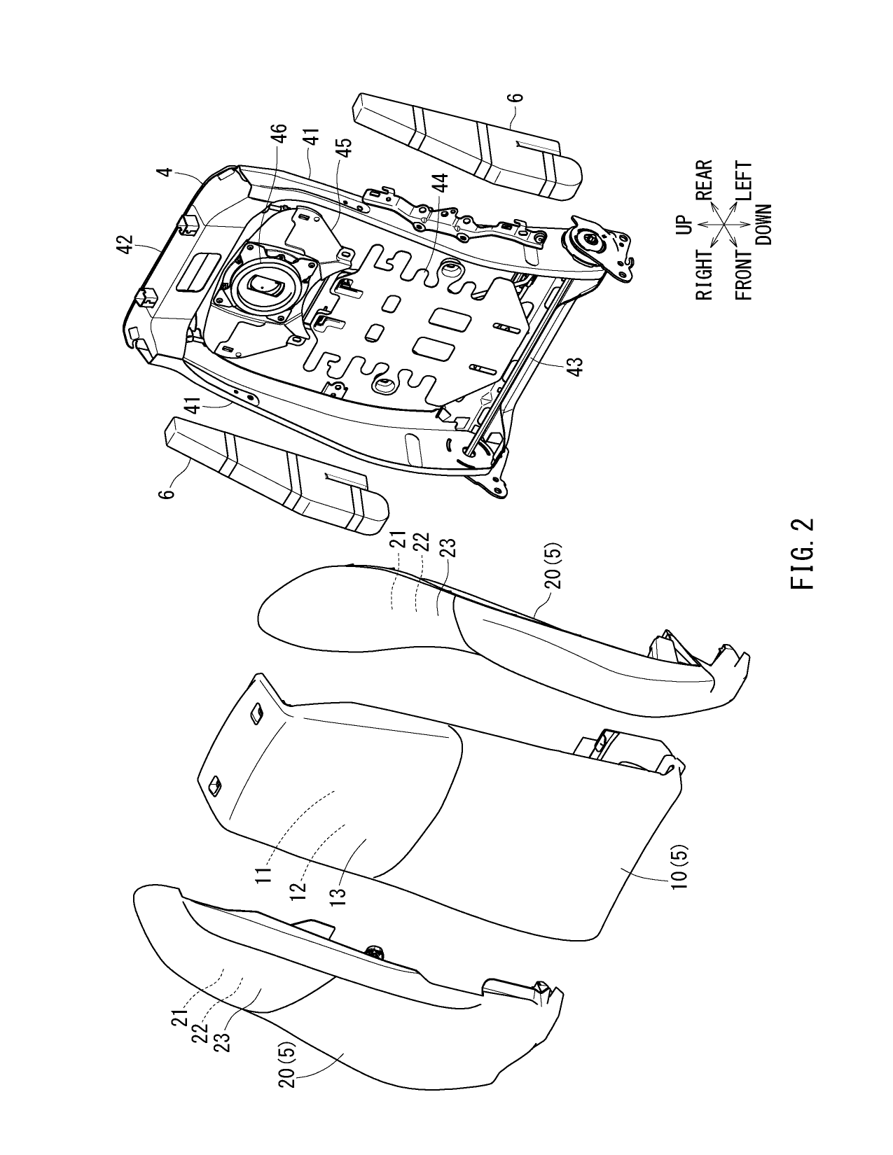

As shown in FIGS. 1 and 2, the seat back 3 includes a frame 4, a structure 5, and a pair of left and right airbag devices 6. The frame 4 forms a framework of the seat back 3. The structure 5, which is assembled to the frame 4, provides a cushioning function and defines the external shape of the seat back 3.

As shown in FIGS. 1 to 4, the frame 4 has a pair of side frames 41, an upper frame 42, and a lower frame 43. The side frames 41 extend vertically along the right and left sides of the seat back 3. The upper frame 42 extends across the upper ends of the side frames 41. The lower frame 43 extends across the lower ends of the side frames 41. The frame 4 has a substantially rectangular shape when viewed from the front. A lumbar plate 44 is arranged between the upper frame 42 and the lower frame 43. A fan 46 is attached to the frame 4 via a fan mounting plate 45 positioned between the upper frame 42 and the lumbar plate 44. The fan 46 draws in air from the front side and discharges the air radially outward through an outlet 46a at an outer edge thereof.

As shown in FIGS. 1 to 5, the structure 5 includes a main structure 10 at a central portion in the seat width direction and a pair of left and right side structures 20 on opposite sides of the main structure 10. The main structure 10 supports the lower back and upper back of the seated occupant from the rear side. The side structures 20 support the lower back and upper back of the seated occupant from the sides.

The main structure 10 includes a main support member 11, a main pad 12, and a main cover 13. The main support member 11 is typically made of resin. The main pad 12 is a cushioning body disposed on the front side of the main support member 11 and is supported by the main support member 11 against the frame 4. The main cover 13 covers the main pad 12 from the front side.

The main support member 11 has a substantially rectangular shape when viewed from the front, with its longitudinal axis oriented in the vertical direction. An opening 11a for air intake by the fan 46 is formed in an upper portion of the main support member 11. Furthermore, on the rear side of the main support member 11, an upper rib 30 is disposed at a position corresponding to the lower thoracic region of the seated occupant. A lower rib 50 is disposed at a position corresponding to the upper pelvic region of the seated occupant. Here, the upper rib 30 and the lower rib 50 correspond to the “ribs” recited in the claims.

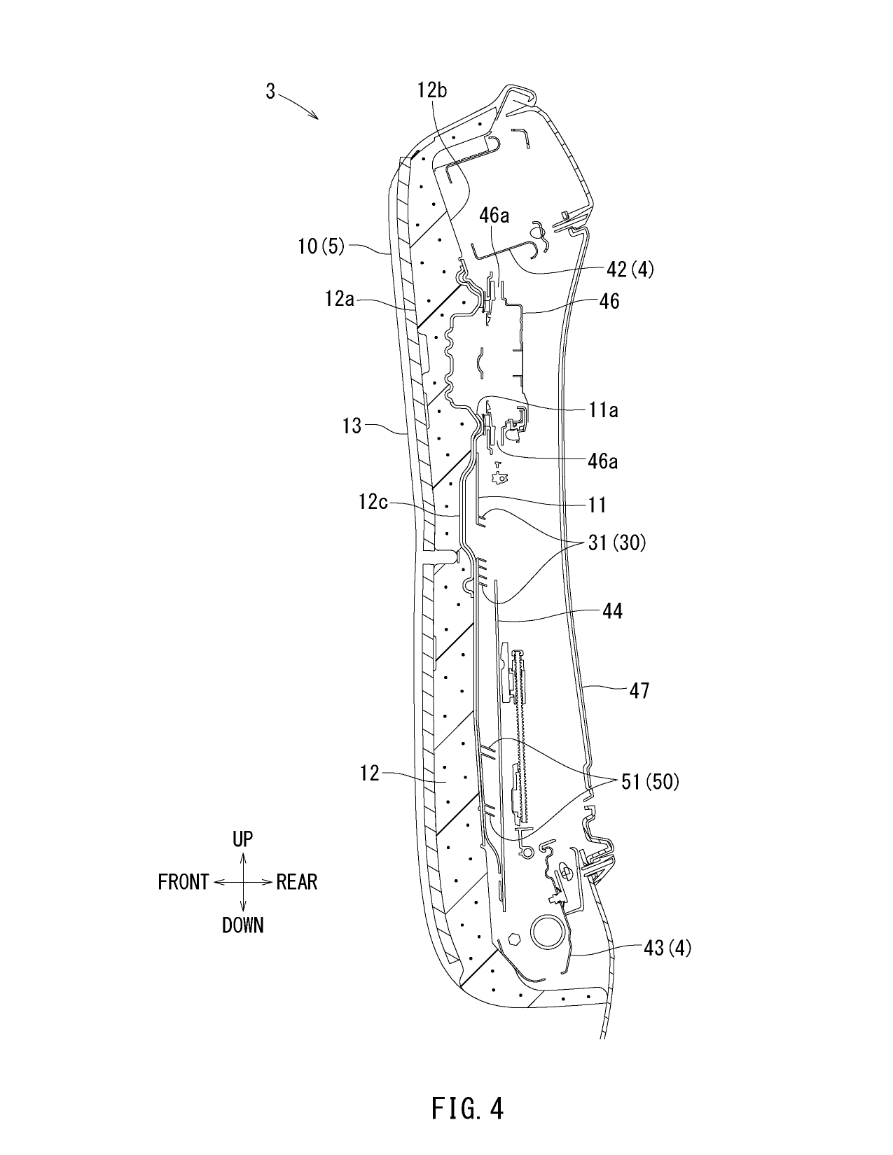

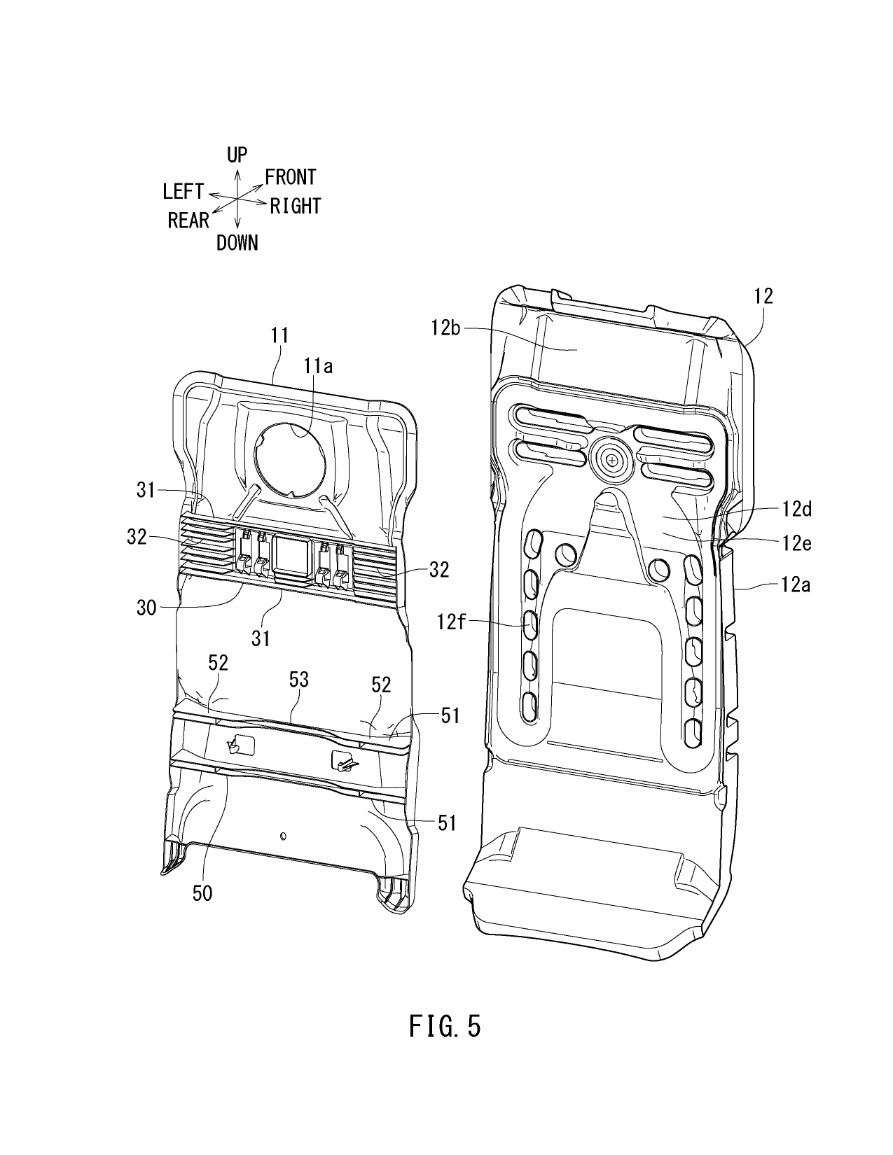

As shown in FIGS. 4 and 5, long ribs 31 are respectively disposed at the upper and lower parts of the upper rib 30 in the vertical direction, extending laterally to the left and right ends of the main support member 11. On both the left and right end sides of the upper rib 30, seven short ribs 32 extend laterally between the upper and lower long ribs 31. The height (front-to-rear dimension) of the long ribs 31 and the short ribs 32 is approximately the same. The lateral distance between the left and right short ribs 32 is about 70 mm to 130 mm. This arrangement results in a lateral bending stiffness of the section of the main support member 11 where the upper rib 30 is located being lower in the center and higher toward the left and right end portions.

As shown in FIGS. 4 and 5, double ribs 51 are disposed at the upper and lower parts of the lower rib 50 in the vertical direction, extending parallel in the lateral direction to the lateral ends of the main support member 11. The double ribs 51 are formed by two identically shaped ribs arranged vertically. The double ribs 51 are spaced apart vertically in pairs at positions corresponding to the upper pelvis of the seated occupant. The height (front-to-rear dimension) of the double ribs 51 is set higher at side portions 52 near the left and right ends and lower at a center portion 53. The height gradually changes between the side portions 52 and the center portion 53 to create a smooth transition. The lateral distance between the left and right side portions 52 is approximately 70 mm to 130 mm. Consequently, the lateral bending stiffness of the portion where the lower ribs 50 of the main support member 11 are arranged is lower in the center and higher at the left and right end portions.

The main support member 11 is fixed to the fan mounting plate 45 at an upper rear surface thereof, to the lumbar plate 44 at a rear surface thereof at approximately the center in the vertical direction, and to the lower frame 43 at a lower rear surface thereof.

As shown in FIGS. 4 and 5, the main pad 12 is an elastic body made of a polyurethane resin foam molded body. Viewed from the front, the main pad 12 has a substantially rectangular shape with its major axis oriented in the vertical direction. A vertical dimension of the main pad 12 is longer than a vertical dimension of the main support member 11, while a lateral dimension of the main pad 12 is approximately the same as a lateral dimension of the main support member 11. A rear surface 12b of the main pad 12 is formed with concave portions 12d that open rearward, including six portions extending in the lateral direction in an upper portion and portions extending in the vertical direction in side portions. A bottom surface 12e of the concave portion 12d is approximately half the thickness of the main pad 12 in the front-rear direction. Multiple air-permeable through-holes 12f are formed between the bottom surface 12e and a front surface 12a. A felt 12c, which is a nonwoven fabric with a high basis weight performed by thermoforming, is integrally foam-molded and arranged on the wall surface portions of the concave portions 12d during the molding of the main pad 12. The felt 12c has its rigidity increased and is firmly bonded as a portion of the raw material of the main pad 12 impregnates and solidifies during the foam molding of the main pad 12.

As shown in FIG. 4, the main cover 13 is a bag-shaped cover member formed by sewing together multiple pieces, opening toward the rear. The main structure 10 is formed by placing the main cover 13 over the main pad 12 positioned in front of the main support member 11 from the front side and securing a rear opening end portion of the main cover 13 to a rear surface of an outer peripheral edge of the main support member 11. This causes the rear opening of the concave portion 12d in the main pad 12 to be covered by the main support member 11, and the space between the bottom surface 12e and the main support member 11 becomes part of an air passage.

As shown in FIG. 2, the side structure 20 includes a side support member 21, a side pad 22, and a side cover 23. The side support member 21 is made of resin. The side pad 22 is a cushioning body disposed on a front side of the side support member 21 and is supported by the side support member 21 relative to the frame 4. The side cover 23 covers the side pad 22 from the front. The side pad 22 is an elastic body formed of a polyurethane resin foam molded body and has an outer shape substantially the same as that of the side support member 21 when viewed from the front. The side cover 23 is a bag-shaped cover member formed by sewing together multiple pieces and having an opening toward the rear. The side structure 20 is assembled by placing the side cover 23 over the side pad 22 positioned on the front side of the side support member 21 from the front and securing the rear opening end portion to a rear surface of an outer peripheral edge of the side support member 21.

The assembly procedure for the seat back 3 is described below. First, as shown in FIGS. 2 to 4, the fan mounting plate 45 and the lumbar plate 44 are disposed between the side frames 41 of the frame 4 so as to extend across the upper frame 42 and the lower frame 43. Next, the airbag device 6 is mounted on an outer side surface of each side frame 41 in the seat width direction. Thereafter, pre-assembled left and right side structures 20 are attached to the frame 4 by securing side support members 21 at predetermined positions with screws. Subsequently, the pre-assembled main structure 10 is attached to the frame 4 with a rear surface of the main support member 11 brought into contact with front surfaces of the fan mounting plate 45 and the lumbar plate 44. The upper portion of the main support member 11 is then secured to the fan mounting plate 45, and the lower portion is secured to a rear portion of the lower frame 43. Finally, a backboard 47 is attached to the rear side of the frame 4 so as to cover the rear side of the frame 4.

The seat back 3 assembled as described above is secured to the seat cushion 2 as shown in FIG. 1 so as to form an automotive seat 1, and the automotive seat 1 is secured to a vehicle floor F.

The present embodiment, configured as described above, exhibits the following advantageous effects. The main structure 10 comprises the main cover 13, the main pad 12, and the main support member 11. Upper ribs 30 are disposed at the main support member 11 at a portion corresponding to a lower thoracic region of the seated occupant, and lower ribs 50 are disposed at a portion corresponding to an upper pelvic region, each extending in the seat width direction. This arrangement enhances the rigidity of the portions of the main support member 11 corresponding to the lower thoracic region and the upper pelvic region of the seated occupant, thereby allowing the seated occupant to maintain a proper posture and sit comfortably.

Furthermore, the upper ribs 30 are configured to include only two long ribs 31 in a central portion of the seat width direction, while side portions on both sides of the seat width direction are configured with nine ribs including the long ribs 31 and short ribs 32. The height of the double ribs 51 of the lower ribs 50 is configured such that the height is greater at side portions 52 near the left and right ends and smaller at a center portion 53. This configuration prevents excessive pressure on the spinal region, thereby improving seating comfort.

In addition, since the upper ribs 30 and the lower ribs 50 are disposed on a rear surface (a surface opposite to the seated occupant) of the main support member 11, the likelihood of the seated occupant experiencing discomfort due to the presence of the upper ribs 30 and the lower ribs 50 during seating is reduced.

Another aspect of the present disclosure is characterized in that the ribs are configured such that their height in a central portion of the seat width direction is lower than their height in side portions of the seat width direction, or the number of ribs in the central portion of the seat width direction is fewer than the number of ribs in the side portions of the seat width direction.

The above configuration prevents excessive pressure on the spinal region, thereby improving seating comfort.

Another aspect of the present disclosure is characterized in that the ribs are disposed on the surface of the main support member opposite to the seated occupant.

The above configuration reduces the likelihood of the seated occupant experiencing discomfort due to the presence of the ribs during seating.

Although certain embodiments have been described above, the present disclosure is not limited to their appearance and configuration, and various changes, additions, and deletions are possible to the extent that they do not alter the gist of the invention. For example, the following are examples.

In the above embodiment, the upper ribs 30 are configured with two ribs in a central portion of the seat width direction and nine ribs in side portions of the seat width direction. However, the present disclosure is not limited thereto. The number of ribs in the central portion and the side portions may be configured to be the same, and the height of the ribs in the central portion may be configured to be lower than the height of the ribs in the side portions.

In the above embodiment, the lower ribs 50 are configured such that the number of ribs in a central portion and in side portions of the seat width direction is the same, and the height of the ribs in the central portion is lower than the height of the ribs in the side portions. However, the present disclosure is not limited thereto. The number of ribs in the central portion may be configured to be fewer than the number of ribs in the side portions.

According to the above embodiments, the present disclosure is applied to the seat back 3 of the automobile seat 1, but may also be applied to a seat of a railway vehicle.

The various examples described above in detail with reference to the attached drawings are intended to be representative of the present disclosure and are thus non-limiting embodiments. The detailed description is intended to teach a person of skill in the art to make, use and/or practice various aspects of the present teachings, and thus does not limit the scope of the disclosure in any manner. Furthermore, each of the additional features and teachings disclosed above may be applied and/or used separately or with other features and teachings in any combination thereof, to provide an improved seat back, and/or methods of making and using the same.

What is claimed is:

1. A seat back comprising:
a frame that forms a framework; and
a structure attached to the frame and configured to elastically support a seated occupant, wherein the structure includes:
a main structure positioned at a center portion in a seat width direction; and
a pair of side structures disposed on both sides of the main structure, wherein the main structure includes:
a main pad;
a main cover that covers the main pad; and
a main support member attached to a frame side of the main pad and configured to support the main pad, wherein the main support member has a plurality of ribs that extend in the seat width direction and are arranged on a rear surface of the main support member.

2. The seat back according to claim 1, wherein the plurality of ribs are configured such that a height at a central portion in the seat width direction is lower than a height at both side portions in the seat width direction, or a number of the ribs at the central portion in the seat width direction is fewer than a number of the ribs at both side portions in the seat width direction.

3. The seat back according to claim 1, wherein the plurality of ribs comprises one or more upper ribs positioned at a portion corresponding to a lower thoracic region of the seated occupant.

4. The seat back according to claim 1, wherein the plurality of ribs comprises one or more lower ribs positioned at a portion corresponding to an upper pelvic region of the seated occupant.

5. The seat back according to claim 3, wherein the one or more upper ribs comprise a plurality of long ribs extending laterally to left and right ends of the main support member.

6. The seat back according to claim 5, wherein the one or more upper ribs comprise a plurality of short ribs on both left and right end sides of the one or more upper ribs and extending laterally between the plurality of long ribs.

7. The seat back according to claim 4, wherein the one or more lower ribs comprise double ribs that are identically shaped and arranged vertically in pairs at positions corresponding to the upper pelvis region of the seated occupant.

8. A seat back comprising:
a frame forming a framework; and
a main structure including a main support member, wherein the main support member comprises an upper rib portion disposed at a position corresponding to a lower thoracic region of a seated occupant and a lower rib portion disposed at a position corresponding to an upper pelvic region of the seated occupant.

9. The seat back according to claim 8, wherein the upper rib portion comprises a plurality of long ribs extending across substantially an entirety of a seat width, and a plurality of short ribs disposed between the long ribs, wherein the short ribs are located exclusively at side portions in the seat width direction such that a number of ribs in a central portion is fewer than in the side portions.

10. The seat back according to claim 8, wherein the lower rib portion comprises a pair of double ribs extending parallel in the seat width direction, wherein a height dimension of the double ribs in a front-rear direction is greater at side portions of the main support member and smaller at a central portion to form a smooth transition configured to reduce pressure on a spinal region of the seated occupant.

11. The seat back according to claim 8, wherein the upper rib portion and the lower rib portion are disposed on a rear surface of the main support member opposite to a side facing the seated occupant.

12. The seat back according to claim 8, further comprising a main pad supported by the main support member, wherein a rear surface of the main pad comprises a plurality of concave portions extending radially from a central portion, and wherein the main support member covers openings of concave portions.

13. The seat back according to claim 8, wherein the main support member further comprises an opening for air intake, and wherein the opening is formed in an upper portion of the main support member.
